(19) United States
(12) Patent Application Publication
(10) Pub. No.: US 2025/0362402 A1
(43) Pub. Date: Nov. 27, 2025

(54) OCCUPANCY DETECTOR AND OCCUPANCY DETECTION METHOD

(71) Applicant: NATIONAL SUN YAT-SEN UNIVERSITY, Kaohsiung 80424 (TW)

(72) Inventors: Fu-Kang Wang, Kaohsiung 80424 (TW); Ju-Yin Shih, Kaohsiung 80424 (TW); Ji-Xun Zhong, Kaohsiung 80424 (TW)

(21) Appl. No.: 18/938,600

(22) Filed: Nov. 6, 2024

(30) Foreign Application Priority Data
May 21, 2024 (TW) 113118820

(51) Int. Cl. G01S 13/04

(52) U.S. Cl. CPC G01S 13/04

(57) ABSTRACT

An occupancy detector includes a radar and an occupancy analyzer. The radar is provided to output a radar background signal and a radar detection signal which are time-domain signals. The radar background signal is detected by the radar from an area when a subject is not occupying the area, and the radar detection signal is detected by the radar from the area when the presence of the subject is unknown. The occupancy analyzer is electrically connected to the radar to receive the radar background signal and the radar detection signal, and it is provided to analysis whether a subject is occupying the area based on the radar background signal and the radar detection signal through generalized likelihood ratio test (GLRT).

### CROSS-REFERENCE TO RELATED APPLICATIONS

This application claims priority to R.O.C Patent Application No. 113118820 filed May 21, 2024, the disclosure of which is hereby incorporated by reference in its entirety.

### FIELD OF THE INVENTION

This invention relates to an occupancy detector and an occupancy detection method, and more particularly to an occupancy detector and an occupancy detection method using time-domain signals.

### BACKGROUND OF THE INVENTION

Occupancy detector is provided to determine whether a moving target is occupying in the environment conventionally, and it is also applied on electrical equipment recently, e.g. air conditioner or lamp. The occupancy detector can detect the presence or absence of a moving target in the environment and automatic control the electrical equipment's switch to lower unnecessary power consumption effectively. Commonly used sensors for occupancy detection are passive infrared sensors or cameras which can determine the presence or absence of a moving target according to infrared variation or image intensity variation. However, passive infrared sensors are sensitive to the environment temperature and exhibit a high false alarm rate, the use of cameras may result in user privacy issue, and they both cannot sense subjects behind a barrier. Thus, radar, which is capable of penetration, not affected by the environment temperature and does not show images of user, is proposed to replace passive infrared sensor and camera for occupancy detection.

Radar can detect the phase and time difference between transmitting signals and reflected signals to determine the presence or absence of a moving subject in the environment, but it cannot detect a stationary subject or a subject under lower-velocity movement, only a subject with large movement can be detected. Spectrum analysis of observation signals from radar is required for occupancy detection of a stationary subject or a subject under lower-velocity movement. Nevertheless, real-time occupancy detection using radar is difficult owing to it needs to collect more data length and increases computation complexity.

### SUMMARY OF THE INVENTION

One object of the present invention is to provide an occupancy detector which is employed to determine the presence or absence of a subject within an area through generalized likelihood ratio test (GLRT) based on two time-domain signals, a radar background signal and a radar detection signal.

An occupancy detector of the present invention includes a radar and an occupancy analyzer. The radar is provided to output a radar background signal and a radar detection signal which are time-domain signals. A signal detected by the radar from an area without a subject is the radar background signal, and a signal detected by the radar from the area when the presence of the subject is unknown. The occupancy analyzer is electrically connected to the radar to receive the radar background signal and the radar detection signal, and the occupancy analyzer is provided to analysis whether the subject is occupying the area based on the radar background signal and the radar detection signal through GLRT.

After receiving the radar background signal and the radar detection signal from the radar, the occupancy analyzer can distinguish the subject is occupying the area or not through GLRT. The radar background signal and the radar detection signal are both time-domain signals, so the present invention can achieve accuracy and real-time occupancy detection within a short observation time.

### BRIEF DESCRIPTION OF DRAWINGS

FIG. 1 is block diagram illustrating an occupancy detector in accordance with one embodiment of the present invention.

FIG. 2 is a circuit diagram illustrating a radar in accordance with one embodiment of the present invention.

FIG. 3 shows simulation results of observation signals detected by an occupancy detector in accordance with one embodiment of the present invention.

FIG. 4 shows probability density function of observation signals of FIG. 3.

FIG. 5 shows test statistics derived from probability density function of FIG. 4.

FIG. 6a shows probability density function and cumulative distribution function of test statistics with Doppler phase information leakage.

FIG. 6b shows multiplication of probability density function and cumulative distribution function of test statistics of FIG. 6a.

FIG. 7 shows simulation results of test statistics and thresholds using an occupancy detector in accordance with one embodiment of the present invention.

FIGS. 8a and 8b show simulation results of probability density function and calculated correlation thresholds using an occupancy detector in accordance with one embodiment of the present invention.

### DETAILED DESCRIPTION OF THE INVENTION

With reference to FIG. 1, an occupancy detector 100 in accordance with one embodiment of the present invention includes a radar 110 and an occupancy analyzer 120. The radar 110 is provided to observe an area A to obtain an observation signal Sᵢ, the occupancy analyzer 120 is electrically connected to the radar 110 to receive the observation signal Sᵢ and analysis whether there is a subject occupying the area A based on the observation signal Sᵢ.

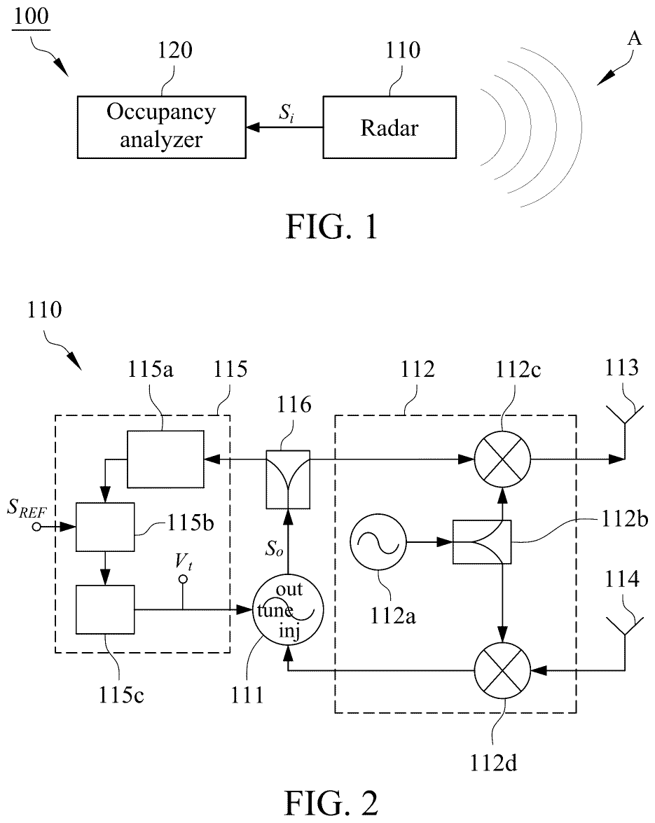

The radar 110 may be a single-frequency continuous wave radar (CW radar) provided to distinguish the presence or absence of a subject within the area A, and it may be a frequency modulated continuous wave radar (FMCW radar) provided to detect whether there is a subject at different distances from the radar 110 within the area A through frequency modulation mechanism. Preferably, the radar 110 is a CW radar or FMCW radar employing self-injection-locked (SIL) technique to increase sensitivity for tiny motions of the subject, like chest movements caused by respiration and heartbeat. FIG. 2 is a circuit diagram of the radar 110 in accordance with one embodiment of the present invention. The radar 110 of this embodiment is a frequency modulated phase- and self-injection locked continuous wave radar (FMPSIL radar) including a self-injection-locked oscillator (SILO) 111, a frequency converter 112, a transmit antenna 113, a receive antenna 114 and a phase-locked-loop (PLL) 115. An oscillation signal S₀ outputting from an output port out of the SILO 111 is split into two paths by a first splitter 116, one path is connected to the frequency converter 112 and the other path is connected to the PLL 115. The frequency converter 112 includes an oscillator 112a, a second splitter 112b, a up mixer 112c and a down mixer 112d. The oscillator 112a output a chirp signal to the second splitter 112b, the chirp signal is split into two paths by the second splitter 112b, one path is connected to the up mixer 112c and the other path is connected to the down mixer 112d. The up mixer 112c receives the oscillation signal S₀ from the first splitter 116, upconverts the oscillation signal S₀ with the chirp signal, and send the upconverted signal to the transmit antenna 113. The transmit antenna 113 transmits the upconverted signal to the area A, and the receive antenna 114 receives a signal reflected from the area A and send the received signal to the down mixer 112d. The received signal is down-converted by the down mixer 112d with the chirp signal and injected into an injection port inj of the SILO 111 to become a self-injection-locked loop. If there is a subject moving in the area A, the signal reflected from the area A and the injection signal contain phase modulation due to the subject movement, and then the SILO 111 is injection-locked to cause frequency deviation.

The PLL 115 contains a frequency divider 115a, a phase frequency detector 115b and a loop filter 115c. The frequency divider 115a receives the oscillation signal S₀ of the SILO 111 from the first splitter 116, divides the oscillation signal S₀ and send the divided oscillation signal S₀ to the phase frequency detector 115b. The phase frequency detector 115b receives a reference signal S_{REF}, compares the reference signal S_{REF} to the divided oscillation signal S₀ and send the comparison result to the loop filter 115c. The loop filter 115c deliver a tuning voltage signal Vₜ obtained after filtering to a tuning voltage port tune of the SILO 111. The tuning voltage signal Vₜ, which is from the PLL 115 and inputting into the tuning voltage port tune of the SILO 111, can cancel the frequency deviation and make oscillation frequency of the SILO 111 stable within appropriate range for occupancy detection. The frequency deviation of the SILO 111 is caused by phase modulation due to the subject's movement so the amplitude of the tuning voltage signal Vₜ contains phase information of the subject's movement.

The radar 110 of this embodiment is a FMPSIL radar which is extremely sensitive to tiny vibration and have oscillational frequency with the same linear variation at each pulse repetition time. The FMPSIL radar can detect multiple range bins at different distances simultaneously, and the detected signals with identical frequency are corresponding to the same range bin, thus, phase signals of different range bins can be extracted from the detected signals with different frequencies. In this embodiment, the phase signals of the same range bins are extracted from the tuning voltage signal Vₜ and reconfigured to become multiple observation signals Sᵢ by a computation unit (not shown). Numbers of the range bins is not limited in the present invention, i=1˜N, N represents the numbers of the range bins depending on hardware architecture resolution of the FMPSIL radar. The occupancy analyzer 120 receives the observation signals Sᵢ from the computation unit of the radar 110 and determines the presence or absence of a subject at each of the range bins based on the observation signals Sᵢ.

With reference to FIG. 1, the occupancy analyzer 120 may be a computer, micro-processer or mobile device with compute capability. The occupancy analyzer 120 receives the observation signal Sᵢ from the computation unit of the radar 110, derives a test statistic of the observation signal Sᵢ through generalized likelihood ratio test (GLRT) and compares the test statistic to a threshold to know whether a subject is occupying the area A.

A null hypothesis and an alternative hypothesis used in GLRT can be expressed by

$$\{ \begin{matrix}{H}_{0} : {s}_{i} ( τ ) = \frac{4 π {f}_{c}}{c} {d}_{0} + n ( t ) \\ {H}_{1} : {s}_{i} ( τ ) = \frac{4 π {f}_{c}}{c} [ {d}_{0} + x ( t ) ] + n ( t )\end{matrix}$$

where sᵢ(τ) is the observation signal of the ith range bin, τ is the slow time along n consecutive chirps, f_{c} is the center frequency of the SILO 111, c is the speed of light, d₀ is the initial distance from the radar 110 to the subject, n(t) is the noise, and x(t) is the movement of the subject. The null hypothesis represents the case where a moving target is absent in the area A, the alternative hypothesis represents the case where moving target is present in the area A. The difference between the null and alternative hypotheses is the target's movement, so it can be known whether a subject is occupying the range bin according to the test statistic value evaluated through GLRT.

In this embodiment, the radar 110 can observe different range bins at the same time, and no subject exists at the first range bin closest to the radar 110. In the occupancy analyzer 120 of this embodiment, the observation signal of the first range bin (i=1) is considered as a radar background signal that satisfies the null hypothesis in GLRT, and the observation signals of the other range bins (i=2˜N) are considered as radar detection signals which are determined to satisfy the null hypothesis or the alternative hypothesis by the occupancy analyzer 120 through GLRT. The test statistic evaluated through GLRT between probability density functions (pdfs) of the radar background signal and the radar detection signal can be derived as

$$T ( s ) = \vert ln \frac{p ( s \vert {H}_{1} )}{p ( s \vert {H}_{0} )} \vert$$

where T(s) is the test statistic, p(·) is the pdf, s is the observation vector, s=[sᵢ(t₀), sᵢ(2t₀), . . . , sᵢ(nt₀)], i represents the ith range bin, n is the chirp pulse, to is the pulse repetition time. The pdfs of the observation signals Sᵢ under the null and alternative hypotheses are considered as Cauchy distribution so that the null and alternative hypotheses can be rewritten as

$$\{ \begin{matrix}{H}_{0} : ρ ( s ) = \frac{1}{π} \cdot \frac{{γ}_{0}}{{γ}_{0}^{2} + {( s - {δ}_{0} )}^{2}} \\ {H}_{1} : ρ ( s ) = \frac{1}{π} \cdot \frac{{γ}_{1}}{{γ}_{1}^{2} + {( s - {δ}_{1} )}^{2}}\end{matrix}$$

where γ₀ and δ₀ are the parameters of the Cauchy distribution under the null hypothesis, γ₁ and δ₁ are the parameters of the Cauchy distribution under the alternative hypothesis. The test statistic for the observation signal at the ith range bin can be derived as

$${T}_{i} ( s ) = \vert {\sum }_{τ = 0}^{n {t}_{0}} ln \frac{[ {γ}_{0}^{2} + {( {s}_{i , 0} ( τ ) - {δ}_{0} )}^{2} ] {γ}_{1}}{[ {γ}_{1}^{2} + {( {s}_{i , 1} ( τ ) - {δ}_{1} )}^{2} ] {γ}_{0}} \vert \begin{matrix}{H}_{1} > \\ < \\ {H}_{0}\end{matrix} {r}_{i} \\$$

where rᵢ denotes the threshold value which may be constant or variable. The test statistic value would approach zero if the pdfs under the null and alternative hypotheses are similar, otherwise, the test statistic value would larger than zero. The alternative hypothesis is decided and represents the presence of a subject in the ith range bin when the test statistic of the ith range bin is greater than the threshold, and the null hypothesis decided and represents that the absence of a subject in the ith range bin while the test statistic of the ith range bin is less than the threshold. The radar background signal and the radar detection signal are both time-domain signals which can be used for GLRT analysis to derive the test statistic, the observation signal is unnecessary to be transformed to frequency domain such that the required observation time for occupancy detection can be reduced.

The parameters of the Cauchy distribution are unknown, and an additional required calculation may increase computation time. Preferably, before deriving the test statistic between the radar background signal and the radar detection signal, the occupancy analyzer 120 applies average removing and amplitude normalization on the pdfs of the radar background signal and the radar detection signal to make the pdfs have zero mean and the same peak-to-peak values. As a result, calculation of the parameters of the Cauchy distribution is not required, the test statistic between the pdfs of the radar background signal and the radar detection signal can be evaluated directly after analyzing the amplitude distribution of the radar background signal and the radar detection signal.

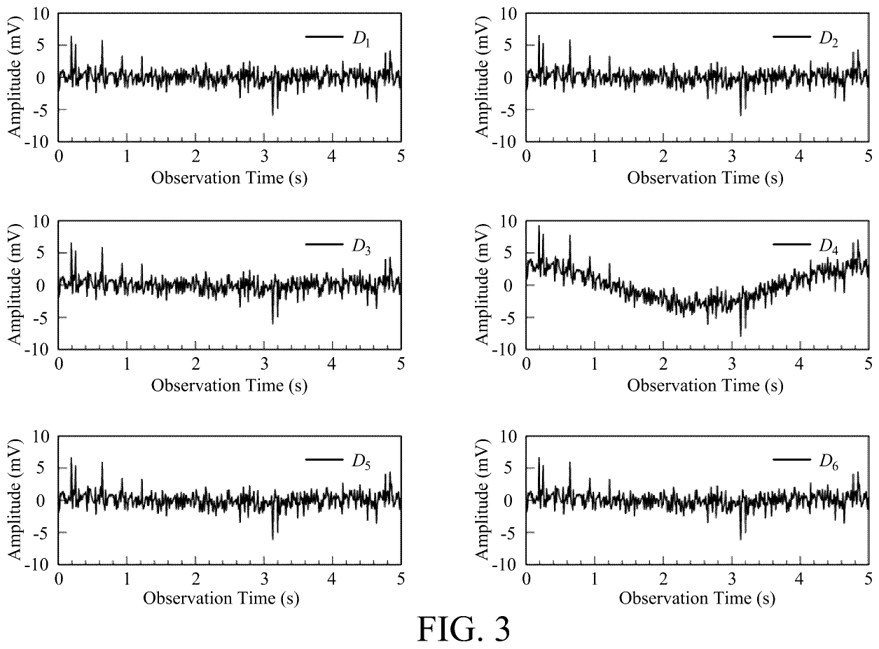

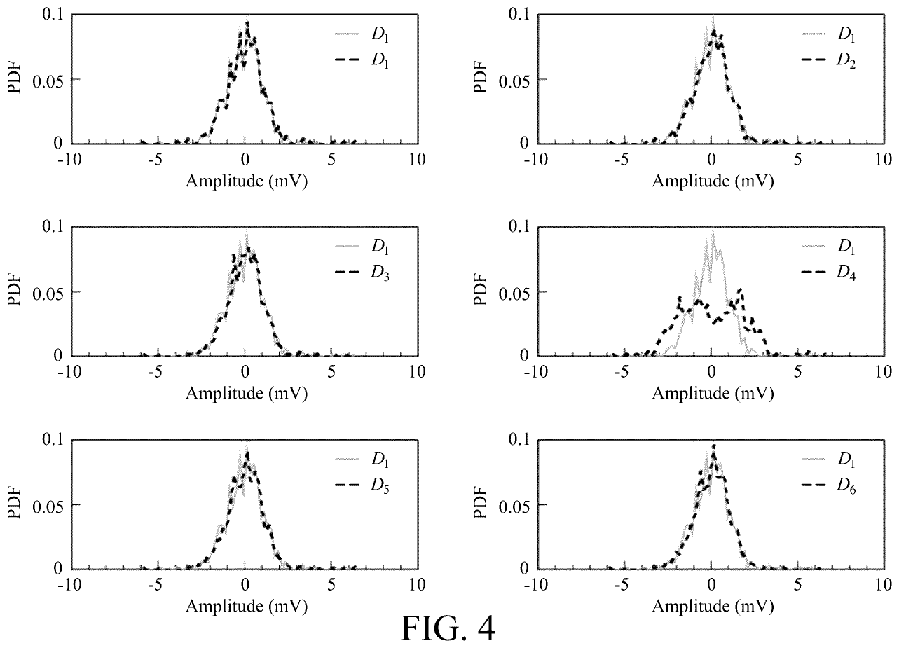

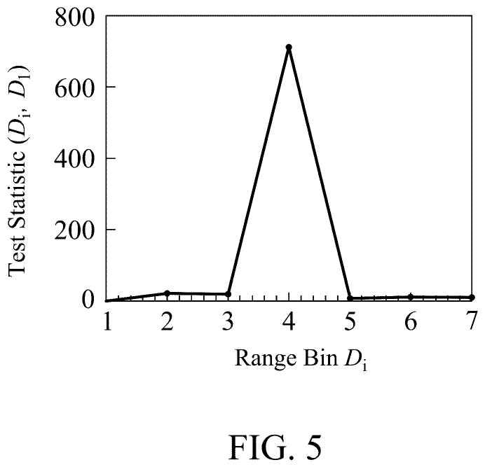

FIG. 3 shows the simulation results of the observation signals Sᵢ using the occupancy detector 100 of this embodiment. The observation signal of the reference range bin D₁ closest to the radar 110 is the radar background signal, the observation signals of the other range bins D₂ to D₆ away from the radar 110 in sequence are the radar detection signals. A subject is seated in front of the radar 110 at the range bin D₄, no subject exists at the range bins D₂, D₃, D₅ and D₆, and the observation time is 5 seconds. FIG. 4 shows the pdfs of the observation signals from the range bins D₁ to D₆. The pdfs at the range bins D₂, D₃, D₅ and De exhibited similar shape compared to the pdf at the reference range bin D₁, and there is a significant difference between the pdf at the range bin D₄ and that at the reference range bin D₁. FIG. 5 shows the test statistic result derived from the pdf of the reference range bin D₁ and that of each of the range bins D₂ to D₆. The test statistic value of the range bin D₄ is higher than that of the range bins D₂, D₃, D₅ and D₆, representing the presence of a subject at the range bin D₄ and the absence of a subject at the other range bins D₂, D₃, D₅ and D₆. The simulation result demonstrates the presence of the subject at the range bin D₄ and the absence of the subject at the range bins D₂, D₃, D₅ and De can be detected within a short observation time of 5 seconds by the occupancy detector 100 of this embodiment.

The threshold can be a constant value or calculated by the occupancy analyzer 120 based on the test statistic using constant false alarm rate (CFAR) detection technique. In the CFAR detection, the test statistic values of neighbor range bins are added, averaged and multiplied by a coefficient to obtain the threshold value of each of the range bins. The coefficient is different in different radars 110.

While a single subject is located near two adjacent range bins, the subject may induce phase modulation on the observation signals of the two adjacent range bins received by the FMCW radar, and a failed prediction result indicating the presence of multiple subjects at the two adjacent range bins may be observed based on evaluation and comparison of the test statistics. Consequently, if a detection result indicating the presence of multiple subjects at the adjacent range bins, the occupancy analyzer 120 needs to further evaluate a correlation test statistic of the radar detection signals corresponding to two adjacent range bins to distinguish whether the radar detection signals of the adjacent range bins are originated from a single subject. The correlation test statistic is evaluated from the pdfs of the radar detection signals of the adjacent range bins through GLRT, and it is compared to a correlation threshold to distinguish whether the radar detection signals from the adjacent range bins are originated from the same subject.

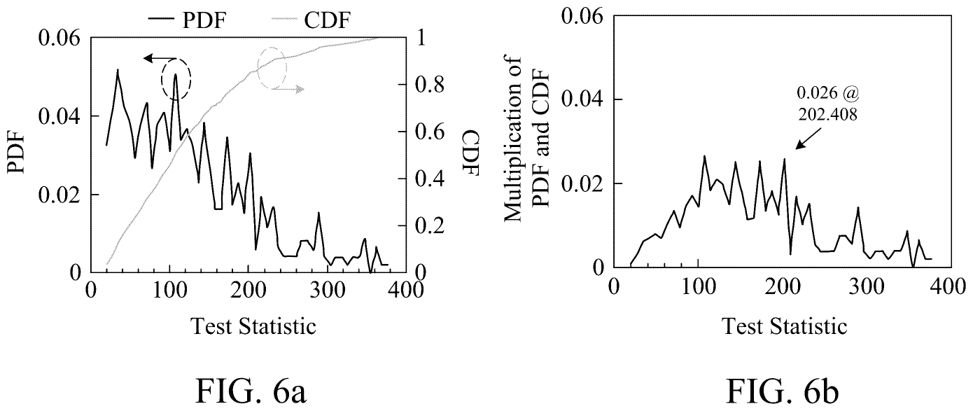

Preferably, the correlation threshold is calculated in advance by multiplying pdf and cumulative distribution function (cdf) values of the test statistics of the radar detection signals from the adjacent range bins when the presence of a single subject is observed. FIG. 6a shows pdf and cdf values of the test statistics evaluated by the radar 110 from the radar detection signals of the adjacent range bins, FIG. 6b shows multiplication of pdf and cdf values of the test statistics and the peak value is 202.048. Hence, the correlation threshold is set as 202.048, and the presence of a single subject is determined when the correlation test statistic is less than the correlation threshold.

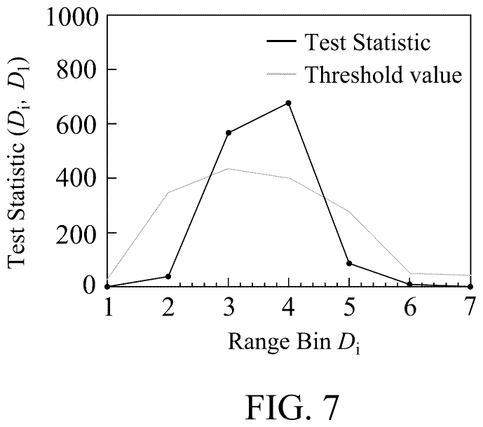

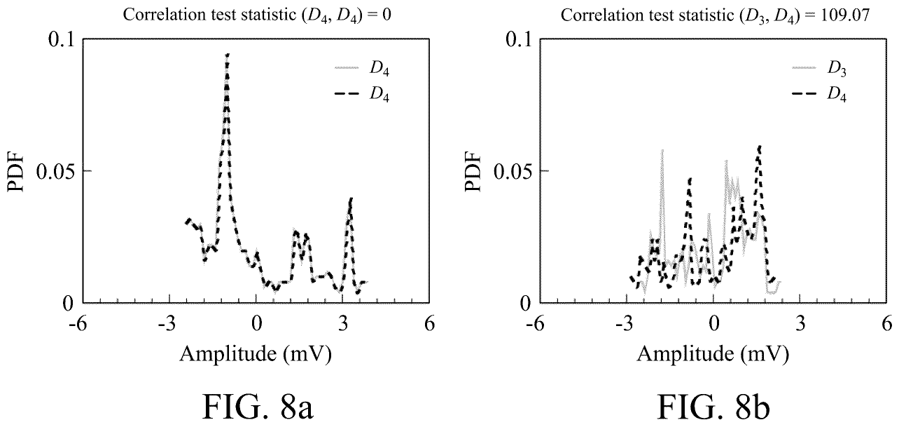

Another simulation result using the occupancy detector 100 of this embodiment is shown in FIG. 7. A subject is seated in front of the occupancy detector 100 at the range bin D₄ but the phase information is leaked into the neighbor range bin D₃, as a result, the test statistic values of the range bins D₃ and D₄ are higher than the threshold values of the range bins D₃ and D₄, and subjects are observed at the range bins D₃ and D₄. The threshold values of this simulation result are calculated through CFAR detection, so they are varied at different range bins. The pdf comparison at the range bin D₄ is shown in FIG. 8a, and the calculated correlation test statistic is zero and less than the correlation threshold 202.048. The pdf comparison at the range bins D₃ and D₄ is shown in FIG. 8b, the correlation test statistic is 109.07 and also less than the correlation threshold, indicating that the two detected range bins D₃ and D₄ are originated from the same subject. Consequently, the correlation test statistic derived from the pdfs of the radar detection signals corresponding to the adjacent range bins can be used to determine the presence of single or multiple subjects.

In other embodiment, the radar 110 is a single-frequency CW radar, not a FMCW radar. Different to the FMCW radar, the single-frequency CW radar can observe the whole area A only, it cannot observe each of the range bins, respectively. Thus, an observation signal from the area A without a subject is used as the radar background signal, then an observation signal from the area A where the presence of a subject is unknown is used as the radar detection signal, and the occupancy analyzer 120 determines the presence or absence of a subject within the area A using the signals.

The receive antenna 114 of the radar 110 may be an antenna array provided to receive the reflected signal from the area A as multiple received signals and synthesis the received signals using digital beamforming technique to increase signal strength and detection sensitivity. Receive antennas in the array antenna receive the same reflected signal with different angles from the area A, so the pdfs of the signals received by the antenna array are similar. Before digital beamforming process, the occupancy analyzer 120 can evaluate a test statistic value between two received signals through GLRT and determine the signals received by the array antenna are normal or abnormal based on the test statistic value.

The radar 110 may be mounted in a wearable device, e.g. smart bracelet, the radar background signal of the radar 110 is a detected signal before the user put on the wearable device, and the radar detection signal of the radar 110 is a detected signal after the user put on the wearable device. The wearable device putting on the user can measure pulse, heartbeat or respiration rate of the user. When the wearable device is put on the user correctly, the test statistic between the radar background signal and the radar detection signal calculated by the occupancy analyzer 120 through GLRT exhibits the presence of a subject in the area. In other hand, when the wearable device is put on the user incorrectly, the test statistic between the radar background signal and the radar detection signal calculated by the occupancy analyzer 120 through GLRT exhibits the absence of a subject in the area. Hence, the occupancy detector 100 of the present invention can be provided to remind the user to wear the wearable device correctly.

After getting the radar background signal and the radar detection signal from the radar 110, the occupancy analyzer 120 can determine the presence or absence of a subject within the area A through GLRT. Owing to the radar background signal and the radar detection signal are both time-domain signals, the occupancy detector 100 can achieve real-time and accuracy occupancy detection within a short observation time.

The scope of the present invention is only limited by the following claims. Any alternation and modification without departing from the scope and spirit of the present invention will become apparent to those skilled in the art.

1. An occupancy detector comprising:
a radar configured to output a radar background signal and a radar detection signal, wherein the radar background signal is detected by the radar from an area when an absence of a subject is known, the radar detection signal is detected by the radar from the area when a presence of the subject is unknown, and the radar background signal and the radar detection signal are time-domain signals; and
an occupancy analyzer electrically connected to the radar to receive the radar background signal and the radar detection signal, the occupancy analyzer is configured to determine the presence or absence of the subject in the area based on the radar background signal and the radar detection signal through generalized likelihood ratio test (GLRT).

2. The occupancy detector in accordance with claim 1, wherein the occupancy analyzer is configured to evaluate a test statistic between the radar background signal and the radar detection signal through GLRT and configured to compare the test statistic to a threshold to determine the presence or absence of the subject in the area.

3. The occupancy detector in accordance with claim 2, wherein the radar is a frequency modulated continuous wave (FMCW) radar, and the test statistic between the radar background signal and the radar detection signal evaluated by the occupancy analyzer through GLRT is derived as
$$T ( s ) = \vert ln \frac{p ( s \vert {H}_{1} )}{p ( s \vert {H}_{0} )} \vert$$
where T(s) is the test statistic, p(·) is probability density function, s is an observation vector, s=[sᵢ(t₀), sᵢ(2t₀), . . . , sᵢ(nt₀)], i is a ith range bin, H₁ is an alternative hypothesis, H₀ is a null hypothesis, the occupancy analyzer is configured to set the observation signal corresponding to the range bin i=1 closest to the FMCW radar to be the radar background signal, configured to set the observation signals corresponding to the other range bins to be a plurality of radar detection signals and configured to evaluate the test statistic between the radar background signal and each of the plurality of radar detection signals, respectively.

4. The occupancy detector in accordance with claim 3, wherein the occupancy analyzer is configured to apply average removing and amplitude normalization on probability density functions of the radar background signal and the plurality of radar detection signals before evaluating the test statistic.

5. The occupancy detector in accordance with claim 3, wherein the threshold is a constant value or calculated by the occupancy analyzer using a constant false alarm rate (CFAR) detection method according to the test statistic.

6. The occupancy detector in accordance with claim 3, wherein the occupancy analyzer is configured to evaluate a correlation test statistic between the radar detection signals of the adjacent range bins and configured to determine the radar detection signals of the adjacent range bins are from a single subject or multiple subjects.

7. The occupancy detector in accordance with claim 6, wherein the occupancy analyzer is configured to compare the correlation test statistic to a correlation threshold and configured to determine the radar detection signals of the adjacent range bins are from a single subject or multiple subjects, the correlation threshold is calculated in advance by multiplying probability density functions and cumulative distribution functions of the test statistics of the radar detection signals of the adjacent range bins when the presence of a single subject is observed.

8. The occupancy detector in accordance with claim 1, wherein the radar includes an antenna array which is configured to receive a signal reflected from the area as a plurality of received signals, the occupancy analyzer is configured to receive the plurality of received signals from the radar, evaluate a test statistic between the plurality of received signals through GLRT and determine whether the plurality of received signals are correct based on the test statistic.

9. An occupancy detection method comprising:
detecting an area and outputting a radar background signal and a radar detection signal by a radar, wherein the radar background signal is detected by the radar from an area when an absence of a subject is known, the radar detection signal is detected by the radar from the area when a presence of the subject is unknown, and the radar background signal and the radar detection signal are time-domain signals; and
receiving the radar background signal and the radar detection signal from the radar by an occupancy analyzer, the occupancy analyzer is configured to determine the presence or absence of the subject in the area based on the radar background signal and the radar detection signal through generalized likelihood ratio test (GLRT).

10. The occupancy detection method in accordance with claim 9, wherein the radar is a frequency modulated continuous wave (FMCW) radar, the occupancy analyzer is configured to evaluate a test statistic between the radar background signal and the radar detection signal through GLRT and configured to compare the test statistic to a threshold to determine the presence or absence of the subject in the area, the test statistic between the radar background signal and the radar detection signal evaluated by the occupancy analyzer through GLRT is derived as
$$T ( s ) = \vert ln \frac{p ( s \vert {H}_{1} )}{p ( s \vert {H}_{0} )} \vert$$
where T(s) is the test statistic, p(·) is probability density function, s is an observation vector, s=[sᵢ(t₀), sᵢ(2t₀), . . . , sᵢ (nt₀)], i is a ith range bin, H₁ is an alternative hypothesis, H₀ is a null hypothesis, the occupancy analyzer is configured to set the observation signal corresponding to the range bin i=1 closest to the FMCW radar to be the radar background signal, configured to set the observation signals corresponding to the other range bins to be a plurality of radar detection signals and configured to evaluate the test statistic between the radar background signal and each of the plurality of radar detection signals, respectively.

11. The occupancy detection method in accordance with claim 10, wherein the occupancy analyzer is configured to apply average removing and amplitude normalization on probability density functions of the radar background signal and the plurality of radar detection signals before evaluating the test statistic.

12. The occupancy detection method in accordance with claim 9, wherein the radar includes an antenna array which is configured to receive a signal reflected from the area as a plurality of received signals, the occupancy analyzer is configured to receive the plurality of received signals from the radar, evaluate a test statistic between the plurality of received signals through GLRT and determine whether the plurality of received signals are correct based on the test statistic.
